(19) United States
(12) Patent Application Publication
(10) Pub. No.: US 2015/0184058 A1
(43) Pub. Date: Jul. 2, 2015

(54) Well Cementing Methods and Apparatuses

(71) Applicant: BAKER HUGHES INCORPORATED, Houston, TX (US)

(72) Inventor: Jose V. Reyes, Bogota (CO)

(73) Assignee: BAKER HUGHES INCORPORATED, Houston, TX (US)

(21) Appl. No.: 14/145,118

(22) Filed: Dec. 31, 2013

(51) Int. Cl. C09K 8/42; E21B 33/16

(52) U.S. Cl. CPC C09K 8/42; E21B 33/16

(57) ABSTRACT

A well cementing method includes using a casing in a wellbore, an annulus between the casing and a formation, and drilling fluid in the casing and the annulus. The method includes placing a cross-linked fluid plug in the casing. A cement slurry is placed in the casing, the cross-linked fluid plug separating the drilling fluid from the cement slurry. The method includes advancing the cement slurry and the cross-linked fluid plug through the casing and then through the annulus. The advancing cross-linked fluid plug expels the drilling fluid from the casing and then from the annulus. A well cementing apparatus includes an external wiper plug in the annulus. The external wiper plug contains a cross-linked gel in contact with the casing and with a wall of the wellbore and separates the drilling fluid from the cement slurry.

### TECHNICAL FIELD

Methods and apparatuses herein pertain to well cementing methods and apparatuses, such as those that use or include cross-linked gel.

### BACKGROUND

The process of preparing wells drilled in subterranean formations, such as hydrocarbon production wells, often includes cementing the well. Known techniques for well cementing protect and seal the wellbore. Cementing may be used to seal the annulus between the wellbore wall and casing in the wellbore. Cementing may also be used to plug portions of a well, including for the purpose of abandonment, to seal a lost circulation zone, etc.

After drilling ceases and before cementing begins, static drilling mud in a wellbore may gel up and become difficult to remove. Often, a spacer fluid is provided between concrete slurry and drilling mud to avoid commingling. Usually, cement slurry and drilling mud are not compatible chemically to the extent that commingling at an interface of the cement slurry and drilling mud may produce thickened or gelled material that may be difficult to remove from the wellbore. Accordingly, cementing methods and apparatuses that remove drilling mud more effectively are desirable.

### SUMMARY

A well cementing method includes using a wellbore in a formation, a casing in the wellbore, an annulus between the casing and the formation, and drilling fluid in the casing and the annulus. The method includes placing a cross-linked fluid plug in the casing. The cross-linked fluid plug contains a cross-linked gel. A cement slurry is placed in the casing, the cross-linked fluid plug separating the drilling fluid from the cement slurry. The method includes advancing the cement slurry and the cross-linked fluid plug through the casing and then through the annulus. The advancing cross-linked fluid plug expels the drilling fluid from the casing and then from the annulus.

A well cementing method includes using a wellbore in a formation, a casing in the wellbore, an annulus between the casing and the formation, and drilling fluid in the casing and the annulus. The method includes forming a spacer fluid with ingredients including a polysaccharide gelling agent and a cross-linker, cross-linking the gelling agent, and forming a cross-linked gel. A cross-linked fluid plug is placed in the casing. The cross-linked fluid plug contains the cross-linked gel. The cross-linked gel has a volume of at least 20 barrels. A cement slurry is placed in the casing, the cross-linked fluid plug separating the drilling fluid from the cement slurry. The method includes advancing the cement slurry and the cross-linked fluid plug through the casing and then through the annulus. The advancing cross-linked fluid plug expels the drilling fluid from the casing and then from the annulus. The cross-linked gel exhibits a viscosity greater than 200 cP while advancing the cement slurry and throughout expulsion of the drilling fluid from the annulus.

A well cementing apparatus includes a wellbore in a formation, a casing in the wellbore, an annulus between the casing and the formation, and drilling fluid in the annulus. The apparatus includes an external wiper plug in the annulus, the external wiper plug containing a cross-linked gel in contact with the casing and with a wall of the wellbore. A cement slurry is in the casing and the annulus, the external wiper plug separating the drilling fluid from the cement slurry. The cement slurry is configured to advance the external wiper plug through the annulus. The external wiper plug is configured to expel the drilling fluid from the annulus.

### BRIEF DESCRIPTION OF THE DRAWINGS

Some embodiments are described below with reference to the following accompanying drawings.

FIGS. 1-4 are sequential cross-sectional views conceptually showing a well cementing apparatus at stages of a well cementing method.

FIGS. 5 and 6 are photographs of a cross-linked gel undergoing testing.

### DETAILED DESCRIPTION

Although spacer fluid is known for use in separating cement slurry from drilling mud, the separation fluid sometimes does not sufficiently remove drilling mud from the wellbore during cementing. Spacer fluid, including viscous spacer fluid injected at high pumping rates, may channel through static, gelled drilling mud and ineffectively remove the mud. When spacer fluid pushes a channel into a column of drilling mud, some drilling mud may advance in the channel. Even so, other drilling mud remains behind and contacts cement slurry. Very enlarged wellbores, which include a wider annulus, further complicate drilling mud removal by such a technique. In such larger diameter wellbores, even high pumping rates might not avoid channeling given lower annular velocities down hole in the wider annulus compared to smaller wellbores.

According to one method, well cementing includes using a wellbore in a formation, a casing in the wellbore, an annulus between the casing and the formation, and drilling fluid in the casing and the annulus. Various drilling fluids are known and may be suitable in the methods and apparatuses herein. Drilling mud is one type of drilling fluid and often includes water-based mud containing clay, such as bentonite. As described above, known methods may include placing spacer fluid in the casing prior to placing cement slurry in the casing ultimately to cement the annulus. Spacer fluid may be viscosified, such as by using linear gel or other viscosifying additives, and may be compatible with both the drilling fluid and the cement slurry. However, known spacer fluid is not cross-linked. The spacer fluid may attempt to maintain separation between the cement slurry and the drilling fluid.

In comparison, the method herein includes placing a cross-linked fluid plug in the casing instead of or in addition to the spacer fluid. The cross-linked fluid plug contains a cross-linked gel. A cement slurry is placed in the casing, the cross-linked fluid plug separating the drilling fluid from the cement slurry. The method includes advancing the cement slurry and the cross-linked fluid plug through the casing and then through the annulus. The advancing cross-linked fluid plug expels the drilling fluid from the casing and then from the annulus.

By way of example, the cross-linked gel in the cross-linked fluid plug bears the benefit of exhibiting properties similar to a solid as well as properties similar to a fluid. The solid-like nature of the cross-linked fluid plug reduces mixing of the cement slurry and the drilling fluid, such as when known spacer fluid channels into drilling fluid and contaminates drilling fluid with cement slurry. The solid-like nature of the cross-linked fluid plug maintains continuity of the cross-linked gel while the fluid-like nature of the cross-linked fluid plug allows self-diversion of the cross-linked gel into excentric geometries in the annulus to expel drilling fluid from such geometries. Excentric geometries are not concentric with the center of the casing.

Known linear gel exhibits a viscosity of 10 to 30 centiPoise (cP) while cross-linkers may be used to increase viscosity of cross-linked gels to 100 to 1,000 cP. A viscosity range for the cross-linked gel herein of 100 to 1,000 cP may be suitable. Even so, a viscosity range of 200 to 1,000 cP, such as 800 to 1,000 cP, may be more suitable. Intermediate viscosity values between 200 and 800 cP may also be suitable endpoints for a lesser, included viscosity range. Consequently, the cross-linked gel may exhibit a viscosity greater than 200 cP, such as greater than 800 cP, while advancing the cement slurry. Viscosity range endpoints may depend on the conditions of a well (such as temperature and pressure affecting rheological properties) and physical and chemical properties of the cement slurry and drilling fluid.

For example, a higher viscosity may be warranted for use with a viscous drilling fluid or drilling fluid laden with cuttings. A lower viscosity may be warranted for use in an annulus exhibiting excentric geometries so that the less viscous cross-linked gel more readily self-diverts into the excentric geometries to expel drilling fluid therefrom. Nevertheless, the properties of the cross-linked fluid plug according to the methods and apparatuses herein are such that they benefit both from the fluid properties of a spacer fluid and the solid properties of a wiper plug. Other considerations for selecting properties of the cross-linked gel in the cross-linked fluid plug include the suspending capacity, equivalent circulating density (ECD) limitations, pumping rate limitations, type of job, etc. Different formulations may be developed depending on down hole conditions and job requirements.

A “wiper plug” refers to the bottom or top solid plug often used in known cementing methods. The bottom and top wiper plug may be formed from elastomeric material such that they conform somewhat to the shape of the well casing and may “wipe” drilling fluid or cement slurry therefrom. A bottom wiper plug positioned between the cement slurry and spacer fluid “wipes” drilling fluid from the casing interior as the plug passes through casing to a guide shoe or float shoe. The bottom wiper plug ultimately seats at the guide shoe or float shoe and ruptures, allowing cement slurry then to flow through the bottom plug. A top wiper plug positioned between the cement slurry and displacement fluid “wipes” cement slurry from the casing interior as the displacement fluid advances the cement slurry through the seated bottom wiper plug and into the annulus. Ultimately, the top wiper plug seats on the previously seated bottom wiper plug and the flow of cement slurry through the bottom wiper plug and into the annulus ceases.

The properties of the cross-linked fluid plug described herein allow it to function as an external wiper plug (XWP) in the annulus. That is, just as the above-described wiper plugs “wipe” drilling fluid or cement slurry from the casing interior, the cross-linked fluid plug containing cross-linked gel may flow into the annulus ahead of the cement slurry and “wipe” drilling fluid from the casing exterior and the wall of the wellbore. Known spacer fluids may be ineffective in removing drilling fluid from the casing exterior and the wall of the wellbore for the reasons described above. Known top and bottom cementing plugs, or “internal” wiper plugs being solid are unable to pass through the casing and enter the annulus in a manner such that they can continue a wiping function in the annulus. Consequently, the “cross-linked fluid plug” herein includes features of both “spacer” fluid and wiping “plugs.” As a result the cross-linked fluid plug may function as an external wiper plug in the annulus.

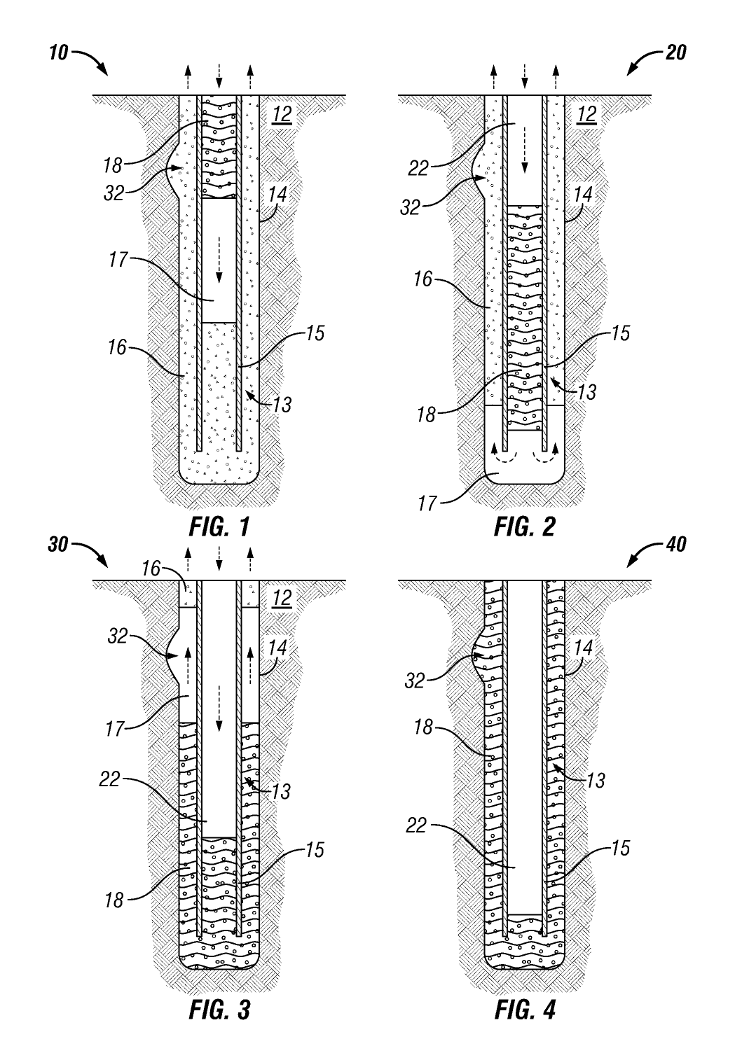

FIGS. 1-4 conceptually show in sequential cross-sectional views a cementing apparatus at stages of a method using a cross-linked fluid plug that functions as an external wiper plug. In FIG. 1, a well 10 in the process of cementing shows a wellbore 14 in a formation 12 and a casing 15 in wellbore 14. An annulus 13 exists between casing 15 and formation 12. A cross-linked fluid plug 17 in casing 15 contains a cross-linked gel, as described herein. A cement slurry 18 in the casing is separated by cross-linked fluid plug 17 from a drilling fluid 16 in casing 15 and annulus 13. A downward pointing arrow in cross-linked fluid plug 17 shows flow direction of cross-linked fluid plug 17 advanced by cement slurry 18 flowing into casing 15, as shown by the downward pointing arrow above cement slurry 18 in FIG. 1. The advancing cross-linked fluid plug 17 expels drilling fluid 16 from casing 15 and then from annulus 13 as shown by upward pointing arrows above drilling fluid 16.

In FIG. 2, a well 20 in process of cementing further shows a displacement fluid 22 advancing cement slurry 18 through casing 15 and expelling cross-linked fluid plug 17 from casing 15 into annulus 13. As cross-linked fluid plug 17 enters annulus 13 in FIG. 2, it begins to function as an external wiper plug. Notably, drilling fluid 16 is shown in FIG. 2 filling an excentric geometry, namely, excentricity 32, in wellbore 14. Often, spacer fluids of viscosities less than 100 cP are ineffective in removing drilling fluids, especially static, gelled drilling mud, from excentric geometries, like excentricity 32.

FIG. 3 shows a well 30 in process of cementing in which displacement fluid 22 is advancing cement slurry 18 into annulus 13. Also, cross-linked fluid plug 17 is shown self-diverting into excentricity 32 and expelling drilling fluid 16 therefrom. After expelling drilling fluid 16 ahead of cross-linked fluid plug 17, annulus 13 may be filled to a desired extent with cement slurry 18 according to known cementing techniques for calculating and placing a suitable volume of cement slurry 18. In FIG. 4, a well 40 in process of cementing shows cement slurry 18 filling annulus 13, including excentricity 32, and awaiting completion of cementing by curing.

By way of additional example, the cross-linked gel may have a volume of at least 20 barrels, such as 20 to 100 barrels, to allow sufficient volume for separation of cement slurry and drilling fluid and for “wiping” of the annulus. More than 100 barrels of cross-linked gel may create excessive friction and complicate pumping the cross-linked fluid plug and cement slurry through the casing and/or annulus. Selection of viscosity for the cross-linked gel likewise involves a trade-off between friction and effectiveness as a further consideration in addition to the considerations above for selecting cross-linked gel viscosity.

The method may further include forming a spacer fluid with ingredients including a gelling agent and a cross-linker and cross-linking the gelling agent. The cross-linked gel may be formed from the spacer fluid. The spacer fluid may consist of water, the gelling agent, the cross-linker, and a buffer. A variety of known gelling agents may be suitable, including polysaccharides, such as guar, cellulose, xanthan, and derivatized forms thereof including hydroxypropyl guar, carboxymethyl hydroxypropyl guar, hydroxyethyl cellulose, and carboxymethyl cellulose. In forming the cross-linked gel, the cross-linking may occur prior to expelling the drilling fluid. In such manner, less likelihood exists that the cross-linked fluid plug will channel into the drilling fluid.

Often, hydraulic fracturing gels include cross-linking delay additives, gel breakers, and fluid loss control additives among many other possible additives to adapt hydraulic fracturing gel to the circumstances of hydraulic fracturing. Gelling agents and cross-linkers known for use in hydraulic fracturing gel may be suitable in the cementing methods herein. However, little or perhaps no need exists for the cross-linked gel in the cementing method to include the additives of hydraulic fracturing gel.

As a result, the spacer fluid used to form the cross-linked gel need not contain a cross-linking delay additive. For a delay additive, reaction kinetics of cross-linking are designed so that viscosity development begins after placement of hydraulic fracturing gel deep within a well. Herein, the cross-linking may occur prior to expelling the drilling fluid such that the cross-linked gel exhibits a viscosity greater than 200 cP, such as greater than 800 cP, while advancing the cement slurry.

In a related manner, gel breakers may be included in hydraulic fracturing gel to significantly reduce viscosity after fracturing for easier removal of the gel from the well. Herein, the cross-linked gel may exhibit a viscosity greater than 200 cP, such as greater than 800 cP, throughout expulsion of the drilling fluid from the annulus. Therefore, the cross-linked gel might not contain a gel breaker. To the extent that the cross-linked gel contains a gel breaker, the gel breaker may be configured for delayed action to maintain desirable properties of the cross-linked gel while advancing through the annulus.

Hydraulic fracturing gel may further include a fluid loss control additive so that fluids prior to cross-linking or after breaking are not lost in the formation, possibly damaging the formation. However, since the cross-linked gel used in the cementing methods herein may be cross-linked prior to expelling the drilling fluid and throughout expulsion of the drilling fluid from the annulus, little or no concern exists for fluid loss into the formation. Consequently, the cross-linked gel might not contain a fluid loss control additive.

According to another method, well cementing includes using a wellbore in a formation, a casing in the wellbore, an annulus between the casing and the formation, and drilling fluid in the casing and the annulus. The method includes forming a spacer fluid with ingredients including a polysaccharide gelling agent and a cross-linker, cross-linking the gelling agent, and forming a cross-linked gel. A cross-linked fluid plug is placed in the casing. The cross-linked fluid plug contains the cross-linked gel. The cross-linked gel has a volume of at least 20 barrels. A cement slurry is placed in the casing, the cross-linked fluid plug separating the drilling fluid from the cement slurry. The method includes advancing the cement slurry and the cross-linked fluid plug through the casing and then through the annulus. The advancing cross-linked fluid plug expels the drilling fluid from the casing and then from the annulus. The cross-linked gel exhibits a viscosity greater than 200 cP while advancing the cement slurry and throughout expulsion of the drilling fluid from the annulus.

By way of example, the features of other methods and apparatuses described herein may be used in the present method. Also, the cross-linked gel may exhibit a viscosity greater than 800 cP while advancing the cement slurry and throughout expulsion of the drilling fluid from the annulus. The cross-linked gel may have a volume of 20 to 100 barrels. The method may further include self-diverting the cross-linked gel into excentric geometries in the annulus and expelling the drilling fluid from the excentric geometries. The cross-linked gel might not contain a gel breaker nor a fluid loss control additive.

It will be appreciated from the methods described herein that a well cementing apparatus includes a wellbore in a formation, a casing in the wellbore, an annulus between the casing and the formation, and drilling fluid in the annulus. The apparatus includes an external wiper plug in the annulus, the external wiper plug containing a cross-linked gel in contact with the casing and with a wall of the wellbore. A cement slurry is in the casing and the annulus, the external wiper plug separating the drilling fluid from the cement slurry. The cement slurry is configured to advance the external wiper plug through the annulus. The external wiper plug is configured to expel the drilling fluid from the annulus. The wells in the process of cementing shown in FIGS. 2 and 3 provide two examples of a well cementing apparatus in which an external wiper plug (cross-linked fluid plug 17) is in contact with the casing and with a wall of the wellbore. Other examples of wells in the process of cementing providing the described apparatus are possible.

By way of example, the features of other methods and apparatuses described herein may be used in the present apparatus. The cross-linked gel may have a volume of at least 20 barrels, such as 20 to 100 barrels. The cross-linked gel may exhibit a viscosity greater than 200 cP, such as greater than 800 cP. The cross-linked gel might not contain a gel breaker nor a fluid loss control additive.

Although FIGS. 1-4 show only cross-linked fluid plug 17 separating drilling fluid 16 and cement slurry 18, additional separation materials may be used. For example, known spacer fluids, chemical washes, wiper plugs, etc. may be utilized according to known methods and apparatuses in addition to cross-linked fluid plug 17.

One example of a process for preparing a cross-linked fluid plug follows. Ingredients are listed in Table 1 and may include known components of the types indicated. The preparation includes the following: 1) Measure the correct volume of water into the blending tank; 2) Check the pH to around 8.0; 3) Slowly add the polymer while agitating the fluid and continue agitating for 20 minutes after all polymer is added; 4) Add the buffer and agitate for 15 minutes; 5) Check pH to around 10.5; and 6) Add the cross-linker once pumping the fluid starts, such as on the fly in the suction side of a high pressure pump.

TABLE 1
Cross-Linked Fluid
Components per 1,000 gallons

| Material | Function | Concentration | Units |
|---|---|---|---|
| Water | Base Fluid | 1,000 | Gallons |
| Polymer | Viscosifying Agent | 20-40 | Pounds |
| X-Linker | Cross-linking Activator | 2.0 | Gallons |
| Buffer | pH Control | 1.5 | Gallons |

A further understanding of the methods and apparatuses described herein may be appreciated from the example below.

### EXAMPLE

A gelling agent (polymer), a cross-linker, and a buffer were combined with water and the rheology evaluated in a Fann Model 50 rheometer available from Fann Instrument Co. in Houston, Texas. The preparation using the components and concentrations of Table 1 above included the following: 1) Poured 500 milliliters (mL) of water in the lab blender; 2) Checked the pH (it was around 8.0); 3) Added the gel while maintaining agitation; 4) Added the buffer; 5) Checked pH (it was around 10.5); 6) Maintained agitation for 15 minutes; 7) Checked viscosity of mixed fluid (it was around 50 cp at 300 RPM in viscometer at 80° F.; 8) Added the X-linker while agitating at low RPM; 9) Placed the desired amount of fluid into the viscometer cup; 10) Ran the rheology test at the desired down hole temperature.

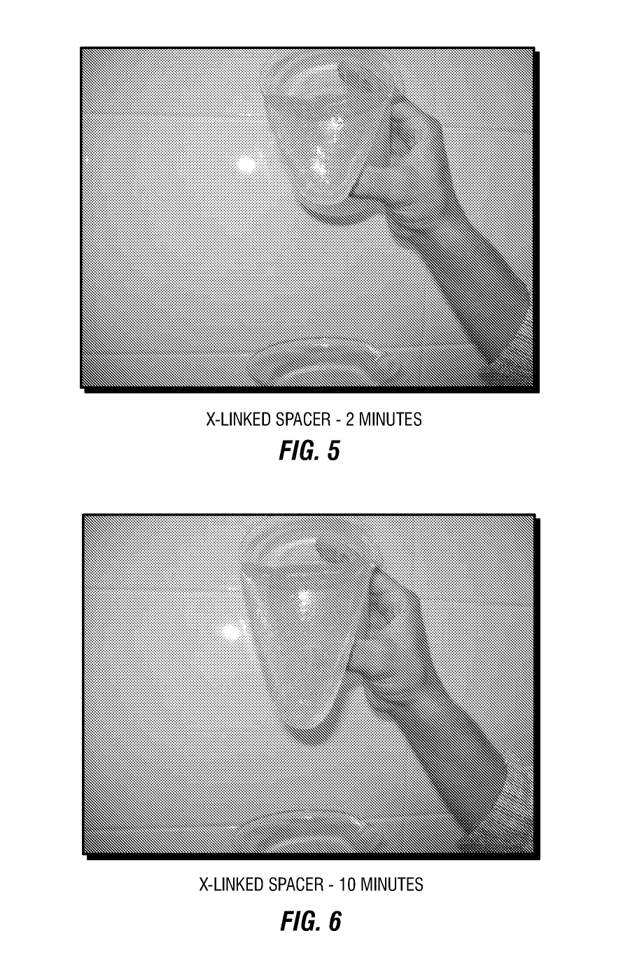

FIG. 5 is a photograph of a pour test conducted after two minutes while FIG. 6 is a photograph of a pour test conducted after 10 minutes demonstrating the rapid viscosity development and cross-linking of the gel evaluated.

Table 2 below provides additional details of viscosity loss over time from 72 minutes to 160 minutes after combining the gelling agent and cross-linker. As will be appreciated, cross-linking of the gel occurs sufficiently quick such that the gel may function as the cross-linked fluid plug described herein upon placing the cross-linked fluid plug in a well casing. Also, viscosity remains sufficiently high, such as greater than 200 cP, over a sufficient time to function as the cross-linked fluid plug throughout expulsion of drilling fluid from the annulus of a well in the process of cementing.

TABLE 2
Rheology Data - Fann 50, X-Linked Spacer, 240° F.

| Apparent Viscosity | Time | | K | |
|---|---|---|---|---|
| (cP) | (min) | n′ | (Lb_{f} sec/ft²) | RPM |
| 400 | 72 | 0.4152 | 0.2514 | 117.61 |
| 350 | 81 | 0.4166 | 0.2496 | 117.61 |
| 300 | 90 | 0.4211 | 0.2468 | 117.61 |
| 250 | 94 | 0.4213 | 0.2466 | 117.61 |
| 200 | 100 | 0.4221 | 0.2454 | 117.61 |
| 150 | 120 | 0.4298 | 0.2403 | 117.61 |
| 100 | 135 | 0.4312 | 0.2398 | 117.61 |
| 45 | 160 | 0.8021 | 0.0129 | 117.61 |

K is the flow consistency index
n′ is the flow behavior index (dimensionless).

In compliance with the statute, the embodiments have been described in language more or less specific as to structural and methodical features. It is to be understood, however, that the embodiments are not limited to the specific features shown and described. The embodiments are, therefore, claimed in any of their forms or modifications within the proper scope of the appended claims appropriately interpreted in accordance with the doctrine of equivalents.

TABLE OF REFERENCE NUMERALS FOR FIGURES

10 well
12 formation
13 annulus
14 wellbore
15 casing
16 drilling fluid
17 cross-linked fluid plug
18 cement slurry
20 well
22 displacement fluid
30 well
32 excentricity
40 well

What is claimed is:

1. A well cementing method comprising:
using a wellbore in a formation, a casing in the wellbore, an annulus between the casing and the formation, and drilling fluid in the casing and the annulus;
placing a cross-linked fluid plug in the casing, the cross-linked fluid plug containing a cross-linked gel;
placing a cement slurry in the casing, the cross-linked fluid plug separating the drilling fluid from the cement slurry; and
advancing the cement slurry and the cross-linked fluid plug through the casing and then through the annulus, the advancing cross-linked fluid plug expelling the drilling fluid from the casing and then from the annulus.

2. The method of claim 1, wherein the cross-linked gel exhibits a viscosity greater than 200 cP while advancing the cement slurry.

3. The method of claim 1, wherein the cross-linked gel exhibits a viscosity greater than 800 cP while advancing the cement slurry.

4. The method of claim 1, wherein the cross-linked gel has a volume of at least 20 barrels and the cross-linked fluid plug functions as an external wiper plug in the annulus.

5. The method of claim 1, further comprising:
forming a spacer fluid with ingredients including a gelling agent and a cross-linker; and
cross-linking the gelling agent, the cross-linked gel being formed from the spacer fluid.

6. The method of claim 5, wherein the gelling agent comprises a polysaccharide.

7. The method of claim 5, wherein the cross-linking occurs prior to expelling the drilling fluid.

8. The method of claim 5, wherein the spacer fluid does not comprise a cross-linking delay additive.

9. The method of claim 1, wherein the cross-linked gel exhibits a viscosity greater than 200 cP throughout expulsion of the drilling fluid from the annulus.

10. The method of claim 1, wherein the cross-linked gel exhibits a viscosity greater than 800 cP throughout expulsion of the drilling fluid from the annulus.

11. The method of claim 1, wherein the cross-linked gel does not comprise a gel breaker.

12. The method of claim 1, wherein the cross-linked gel does not comprise a fluid loss control additive.

13. A well cementing method comprising:
using a wellbore in a formation, a casing in the wellbore, an annulus between the casing and the formation, and drilling fluid in the casing and the annulus;
forming a spacer fluid with ingredients including a polysaccharide gelling agent and a cross-linker;
cross-linking the gelling agent and forming a cross-linked gel;
placing a cross-linked fluid plug in the casing, the cross-linked fluid plug containing the cross-linked gel and the cross-linked gel having a volume of at least 20 barrels;
placing a cement slurry in the casing, the cross-linked fluid plug separating the drilling fluid from the cement slurry; and
advancing the cement slurry and the cross-linked fluid plug through the casing and then through the annulus, the advancing cross-linked fluid plug expelling the drilling fluid from the casing and then from the annulus, the cross-linked gel exhibiting a viscosity greater than 200 cP while advancing the cement slurry and throughout expulsion of the drilling fluid from the annulus.

14. The method of claim 13, wherein the cross-linked gel exhibits a viscosity greater than 800 cP while advancing the cement slurry and throughout expulsion of the drilling fluid from the annulus.

15. The method of claim 13, wherein the cross-linked gel has a volume of 20 to 100 barrels and the method further comprises self-diverting the cross-linked gel into excentric geometries in the annulus and expelling the drilling fluid from the excentric geometries.

16. The method of claim 13, wherein the cross-linked gel does not comprise a gel breaker nor a fluid loss control additive.

17. A well cementing apparatus comprising:
a wellbore in a formation, a casing in the wellbore, an annulus between the casing and the formation, and drilling fluid in the annulus;
an external wiper plug in the annulus, the external wiper plug containing a cross-linked gel in contact with the casing and with a wall of the wellbore, the cross-linked gel having a volume of at least 20 barrels; and
a cement slurry in the casing and the annulus, the external wiper plug separating the drilling fluid from the cement slurry, the cement slurry being configured to advance the external wiper plug through the annulus, and the external wiper plug being configured to expel the drilling fluid from the annulus.

18. The apparatus of claim 17, wherein the cross-linked gel exhibits a viscosity greater than 200 cP and has a volume of 20 to 100 barrels.

19. The apparatus of claim 18, wherein the cross-linked gel exhibits a viscosity greater than 800 cP.

20. The apparatus of claim 17, wherein the cross-linked gel does not comprise a gel breaker nor a fluid loss control additive.
